(19) United States
(12) Patent Application Publication
(10) Pub. No.: US 2025/0079820 A1
(43) Pub. Date: Mar. 6, 2025

(54) ROUTING STRUCTURE

(71) Applicant: YAZAKI CORPORATION, Tokyo (JP)

(72) Inventors: Mitsunobu Kato, Makinohara-shi (JP); Tatsuya Otsuka, Makinohara-shi (JP); Kazuhiro Tsuchida, Makinohara-shi (JP); Shoya Sugiyama, Makinohara-shi (JP)

(21) Appl. No.: 18/814,411

(22) Filed: Aug. 23, 2024

(30) Foreign Application Priority Data
Aug. 28, 2023 (JP) 2023-137813

(51) Int. Cl. H02G 11/00; B60R 16/02

(52) U.S. Cl. CPC H02G 11/006; B60R 16/0215

(57) ABSTRACT

A routing structure includes: a protector disposed on a sliding door of a vehicle; an electric wire connecting a vehicle body and the sliding door of the vehicle; a rotating member rotatably supported by the protector, the rotating member having a cylindrical shape through which the electric wire is inserted; and a shielding member that follows rotation of the rotating member while sliding with respect to the protector, in which the protector has a routing path through which the electric wire drawn out from the rotating member towards the sliding door is routed, and the shielding member is disposed closer to the vehicle body than to the electric wire in the routing path and covers the electric wire from a space on the vehicle body side.

### CROSS-REFERENCE TO RELATED APPLICATION(S)

The present application claims priority to and incorporates by reference the entire contents of Japanese Patent Application No. 2023-137813 filed in Japan on Aug. 28, 2023.

### BACKGROUND OF THE INVENTION

### 1. Field of the Invention

The present invention relates to a routing structure.

### 2. Description of the Related Art

Conventionally, there is a routing structure for sliding doors. Japanese Patent Application Laid-open No. 2015-154520 discloses a power feeding device including a rotary member and a support member that pivotally supports the rotary member. The rotary member includes: an outer peripheral unit; a harness lead-out unit disposed in the outer peripheral unit; and an appearance wall provided along the outer peripheral unit from the harness lead-out unit, in which the rotation center of the rotary member is disposed to be eccentric with respect to the outer peripheral unit, the support member has an opening to make the harness lead-out unit to be positioned in a freely rotatable manner, and the appearance wall closes the opening when the rotary member rotates in one direction.

There is still room for study in a structure for making electric wires difficult to be visually recognized. For example, since the appearance wall rotates together with the rotary member, it is necessary to design the entire power feeding device in consideration of the rotation locus of the appearance wall. The structure in which the electric wire is covered with a member different from the rotary member leaves room for examination.

### SUMMARY OF THE INVENTION

An object of the present invention is to provide a routing structure in which an electric wire is hardly visually recognized.

In order to achieve the above mentioned object, a routing structure according to one aspect of the present invention includes a protector disposed on a sliding door of a vehicle; an electric wire connecting a vehicle body of the vehicle and the sliding door; a rotating member rotatably supported by the protector, the rotating member having a cylindrical shape through which the electric wire is inserted; and a shielding member that follows rotation of the rotating member while sliding with respect to the protector, wherein the protector has a routing path through which the electric wire drawn out from the rotating member towards the sliding door is routed, and the shielding member is disposed closer to the vehicle body than to the electric wire in the routing path and covers the electric wire from a space on the vehicle body side.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a routing structure according to an embodiment;

FIG. 2 is a plan view of the routing structure according to the embodiment;

FIG. 3 is a plan view of the routing structure according to the embodiment;

FIG. 4 is an exploded perspective view of the routing structure of the embodiment;

FIG. 5 is an exploded perspective view of the routing structure of the embodiment;

FIG. 6 is a plan view illustrating the inside of a protector according to the embodiment;

FIG. 7 is a front view of the routing structure according to the embodiment;

FIG. 8 is a plan view illustrating the inside of the protector according to the embodiment;

FIG. 9 is a front view of the routing structure according to the embodiment;

FIG. 10 is a diagram illustrating the internal structure of a protector according to a first modification of the embodiment;

FIG. 11 is a diagram illustrating the internal structure of a protector according to a second modification of the embodiment;

FIG. 12 is a diagram illustrating the internal structure of the protector according to the second modification of the embodiment;

FIG. 13 is a cross-sectional view of a routing structure according to the second modification of the embodiment;

FIG. 14 is a cross-sectional view of the routing structure according to the second modification of the embodiment;

FIG. 15 is a diagram illustrating the internal structure of a protector according to a third modification of the embodiment;

FIG. 16 is a cross-sectional view of a routing structure according to the third modification of the embodiment;

FIG. 17 is a diagram illustrating the internal structure of the protector according to the third modification of the embodiment; and

FIG. 18 is a cross-sectional view of the routing structure according to the third modification of the embodiment.

### DETAILED DESCRIPTION OF THE PREFERRED EMBODIMENTS

Hereinafter, a routing structure according to an embodiment of the present invention will be described in detail with reference to the drawings. Note that the invention is not limited by the embodiment. In addition, components in the following embodiment include those that can be easily conceived by those skilled in the art or those that are substantially the same.

### EMBODIMENT

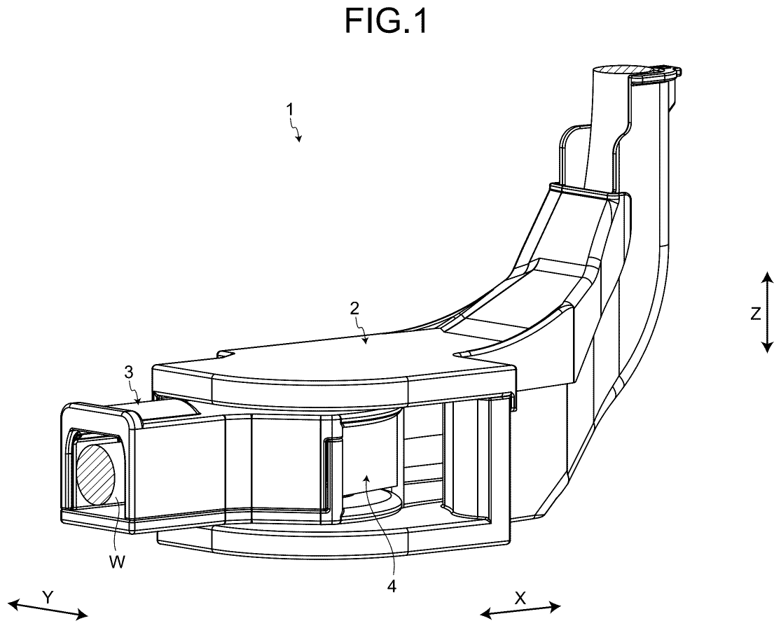

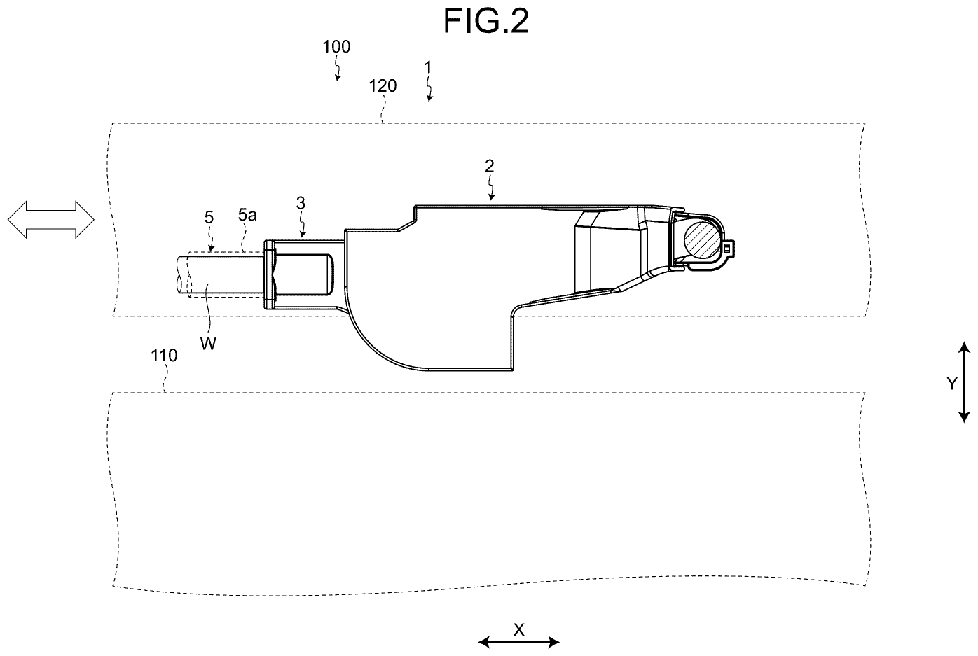

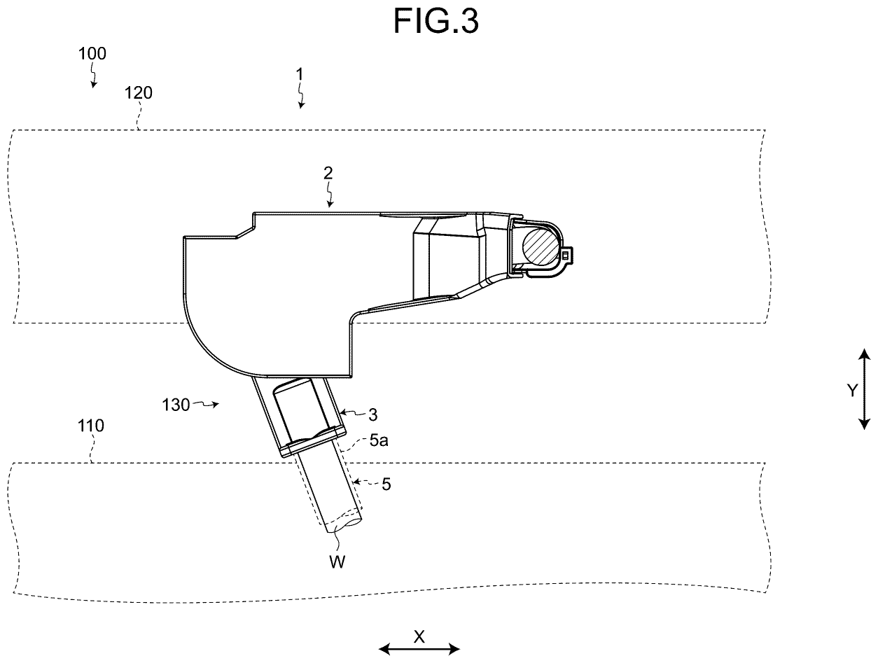

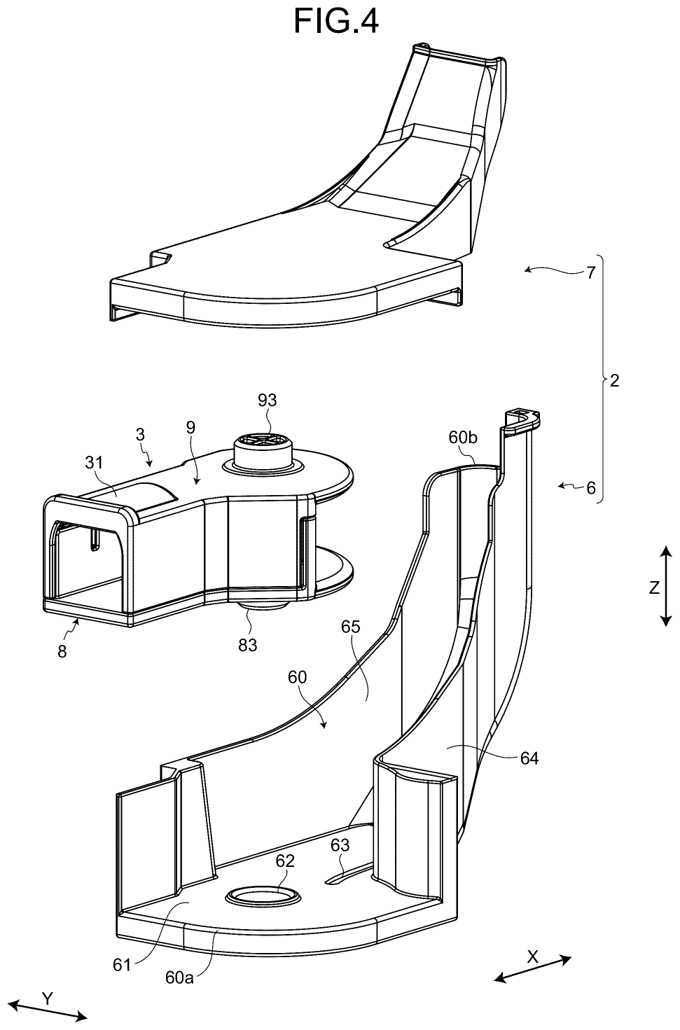

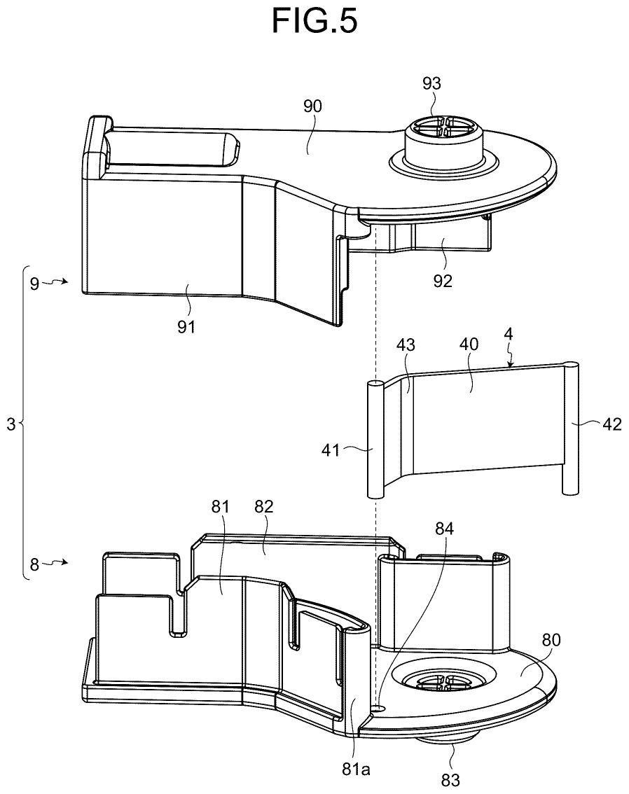

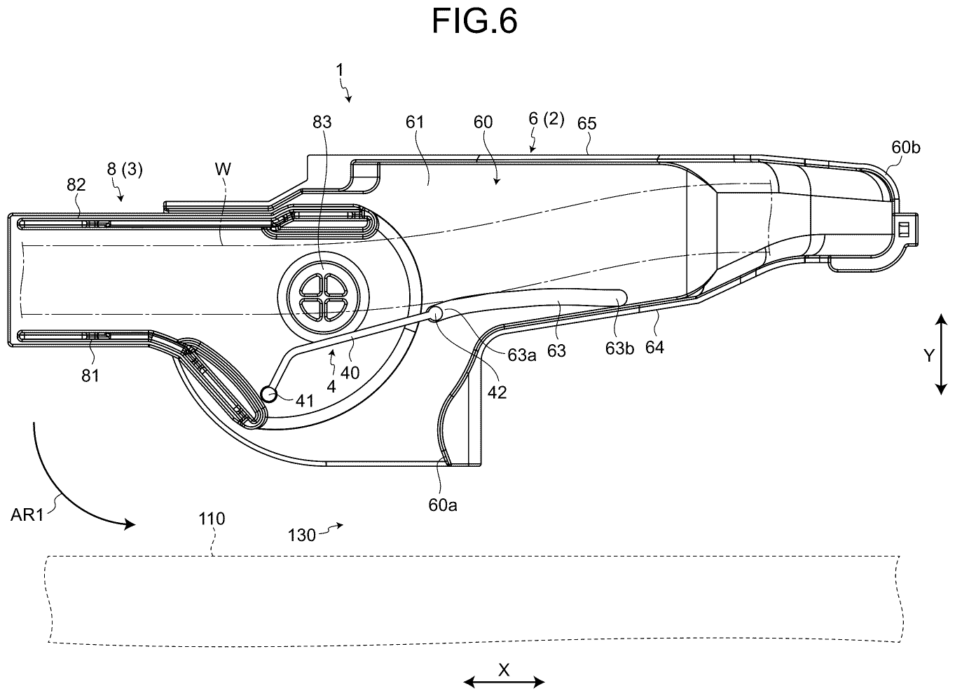

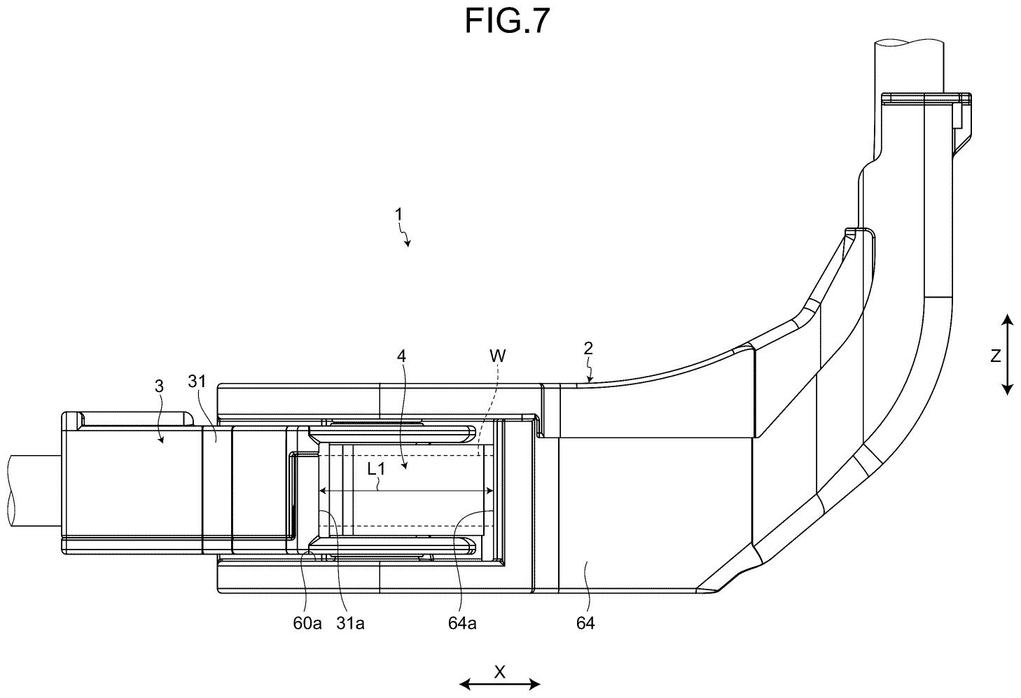

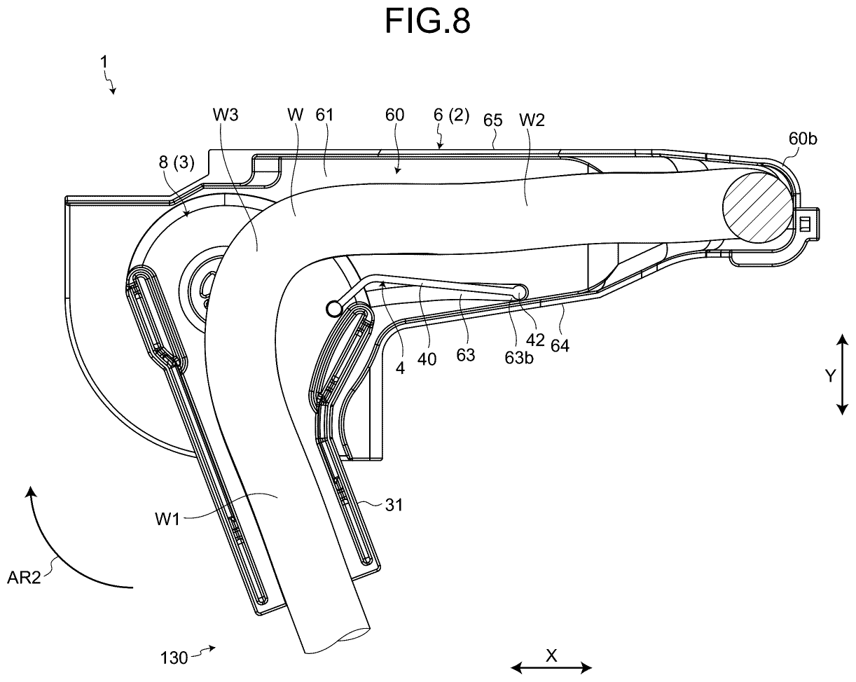

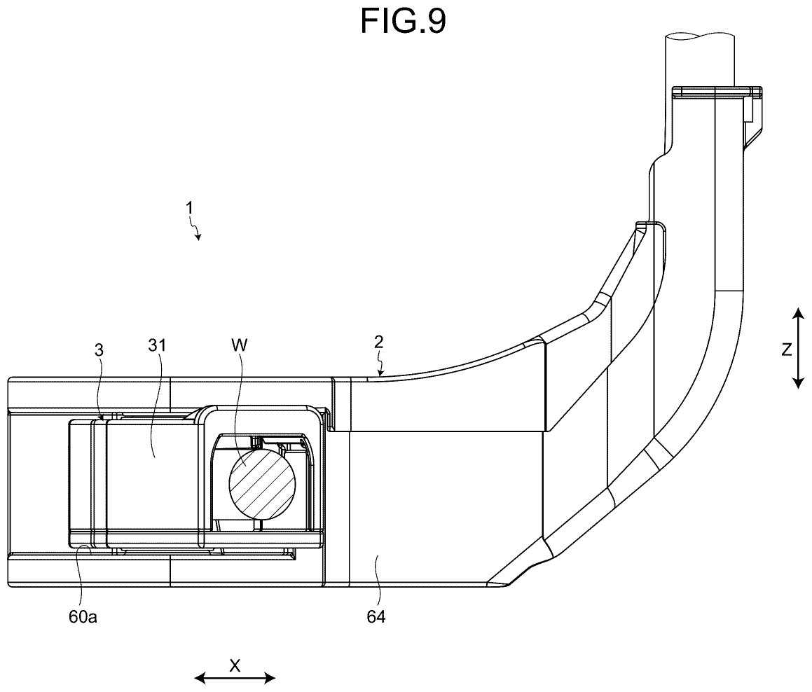

An embodiment will be described with reference to FIGS. 1 to 9. The present embodiment relates to a routing structure. FIG. 1 is a perspective view of a routing structure according to an embodiment, FIGS. 2 and 3 are plan views of the routing structure according to the embodiment, FIGS. 4 and 5 are exploded perspective views of the routing structure according to the embodiment, FIG. 6 is a plan view illustrating the inside of a protector according to the embodiment, FIG. 7 is a front view of the routing structure according to the embodiment, FIG. 8 is a plan view illustrating the inside of the protector according to the embodiment, and FIG. 9 is a front view of the routing structure according to the embodiment.

As illustrated in FIG. 1, the routing structure 1 of the present embodiment includes a protector 2, a rotating member 3, a shielding member 4, and an electric wire W. As illustrated in FIGS. 2 and 3, the electric wire W connects a vehicle body 110 of the vehicle 100 and a sliding door 120. The electric wire W is connected to a power source such as a battery or a control unit such as an ECU in the vehicle body 110.

The sliding door 120 slides in a first direction X with respect to the vehicle body 110. The first direction X is, for example, the front-rear direction of the vehicle 100. The sliding door 120 slides while being guided by a rail disposed on the vehicle body 110, for example. The sliding door 120 may slide by an operation of a link mechanism that connects the vehicle body 110 and the sliding door 120.

FIG. 2 is a diagram illustrating the routing structure 1 when the sliding door 120 is at a fully closed position. When the sliding door 120 is at the fully closed position, as illustrated in FIG. 2, the electric wire W extends from the protector 2 in the first direction X. FIG. 3 is a diagram illustrating the routing structure 1 when the sliding door 120 is at a fully open position. When the sliding door 120 is in the fully open position, as illustrated in FIG. 3, the electric wire W extends from the protector 2 in a second direction Y. The second direction Y is, for example, the width direction of the vehicle 100. When the sliding door 120 is at the fully open position, the rotating member 3 protrudes from the protector 2 towards a space 130 on the vehicle body 110 side. In the routing structure 1 of the present embodiment, the rotation angle of the rotating member 3 when the sliding door 120 moves between the fully closed position and the fully open position is larger than 90°.

The protector 2 is disposed on the sliding door 120 and held by the sliding door 120. The rotating member 3 is rotatably supported by the protector 2. As illustrated in FIGS. 2 and 3, the rotating member 3 rotates as the extending direction of the electric wire W changes due to the movement of the sliding door 120.

A cylindrical exterior member 5 may be disposed between the rotating member 3 and the vehicle body 110. In this case, the rotating member 3 holds one end 5a of the exterior member 5. The other end of the exterior member 5 is held by a holding member disposed in the vehicle body 110. The electric wire W is inserted into the exterior member 5 and protected by the exterior member 5.

The shielding member 4 shields the electric wire W inside the protector 2 from the space on the vehicle body 110 side. The shielding member 4 is slidable with respect to the protector 2 and is structured in such a manner as to follow the rotation of the rotating member 3.

As illustrated in FIG. 4, the protector 2 includes a protector body 6 and a cover 7. The protector body 6 and the cover 7 are molded from, for example, insulating synthetic resin. The protector body 6 has a semi-cylindrical shape. The protector body 6 has a routing path 60 through which the electric wire W is routed. The routing path 60 includes a bottom wall 61, a first side wall 64, and a second side wall 65.

The routing path 60 has a first opening 60a and a second opening 60b. The first opening 60a is an opening through which the electric wire W is drawn out towards the vehicle body 110. The vicinity of the first opening 60a in the routing path 60 has a tapered shape in which the opening width decreases as it is closer to the second opening 60b. The first opening 60a is formed in such a manner as not to interfere with the rotating member 3 on the basis of the rotation range of the rotating member 3. The second opening 60b is an opening through which the electric wire W is drawn out towards the sliding door 120. The illustrated second opening 60b opens upward.

The bottom wall 61 of the routing path 60 includes a through hole 62 that rotatably supports a rotating shaft 83 of the rotating member 3. The through hole 62 is disposed in the vicinity of the first opening 60a. The bottom wall 61 includes a guide groove 63 that guides the shielding member 4. The guide groove 63 extends from the vicinity of the through hole 62 towards the second opening 60b along the routing direction of the electric wire W.

The cover 7 is a member that engages with the protector body 6 and covers the routing path 60 from above. The protector body 6 and the cover 7 surround the electric wire W routed in the routing path 60 and protect the electric wire W. The cover 7 has a recess that rotatably supports a rotating shaft 93 of the rotating member 3. The recess is disposed at a position facing the through hole 62 of the protector body 6.

As illustrated in FIG. 5, the rotating member 3 includes a first member 8 and a second member 9. The first member 8 and the second member 9 are molded from, for example, insulating synthetic resin. The first member 8 has a bottom wall 80, a first side wall 81, and a second side wall 82. The bottom wall 80, the first side wall 81, and the second side wall 82 constitute a semi-cylindrical portion having a rectangular cross-sectional shape. The rotating shaft 83 having a columnar shape is provided at an end of the bottom wall 80. The rotating shaft 83 is rotatably supported by the through hole 62 of the protector 2.

The second member 9 has a top wall 90, a first side wall 91, and a second side wall 92. The top wall 90, the first side wall 91, and the second side wall 92 constitute a semi-cylindrical portion having a rectangular cross-sectional shape. The rotating shaft 93 having a columnar shape is provided at an end of the top wall 90. The rotating shaft 93 is rotatably supported by the cover 7 of the protector 2.

As illustrated in FIG. 4, the rotating member 3 includes a cylindrical portion 31 having a rectangular cylindrical shape. The cylindrical portion 31 includes the semi-cylindrical portion of the first member 8 and the semi-cylindrical portion of the second member 9. The rotating member 3 is rotatable about the rotating shafts 83 and 93. The rotating member 3 follows the electric wire W by changing the direction of the cylindrical portion 31 when the sliding door 120 is opened and closed.

As illustrated in FIG. 5, the shielding member 4 is a plate-like member. The shielding member 4 is molded from, for example, insulating synthetic resin. The shielding member 4 includes a body 40, a first shaft portion 41, and a second shaft portion 42. The body 40 has a substantially rectangular plate shape in plan view. The body 40 has a bent portion 43. The body 40 is bent at an obtuse angle at the bent portion 43.

The first shaft portion 41 is rotatably supported by the rotating member 3. The shielding member 4 is connected with the rotating member 3 at the first shaft portion 41. The second shaft portion 42 is guided by the guide groove 63 of the protector 2. The first shaft portion 41 is provided at one end of the body 40 and protrudes from both sides of the body 40 in the width direction of the body 40. The first member 8 of the rotating member 3 has a recess 84 that rotatably supports the first shaft portion 41. The recess 84 is adjacent to an end 81a of the first side wall 81. The end 81a is an end close to the rotating shaft 83. That is, the recess 84 is disposed such that the first side wall 81 and the shielding member 4 can form a continuous wall portion to cover the electric wire W. The second member 9 has a recess similar to the recess 84 and rotatably supports the first shaft portion 41. That is, the rotating member 3 rotatably supports both ends of the first shaft portion 41.

The second shaft portion 42 is provided at an end of the body 40 on a side opposite to the first shaft portion 41 side. The second shaft portion 42 protrudes from one side of the body 40 in the width direction of the body 40.

Illustrated in FIG. 6 is the inside of the protector 2 when the sliding door 120 is at the fully closed position. In FIG. 6, the cover 7 of the protector 2 and the second member 9 of the rotating member 3 are omitted. The shielding member 4 is disposed on the vehicle body 110 side with respect to the electric wire W in the routing path 60. That is, the shielding member 4 is disposed in such a manner as to cover the electric wire W from the space 130 on the vehicle body 110 side.

As illustrated in FIG. 6, the guide groove 63 has a first end 63a and a second end 63b. The first end 63a is an end located on the first opening 60a side. The second end 63b is an end located on the second opening 60b side. When the sliding door 120 is at the fully closed position, the second shaft portion 42 of the shielding member 4 is positioned at the first end 63a.

The first end 63a is disposed in such a manner as to overlap the first side wall 64 when viewed from the second direction Y. Therefore, the shielding member 4 can cover the routing path 60 when viewed from the space 130 on the vehicle body 110 side. As illustrated in FIG. 6, the guide groove 63 of the protector 2 is disposed along a first side wall 64. Therefore, the shielding member 4 is positioned on the first side wall 64 side with respect to the electric wire W in the routing path 60. The shielding member 4 can cover the electric wire W routed between the first side wall 64 and the second side wall 65.

FIG. 7 is a front view of the protector 2, the rotating member 3, and the shielding member 4 when the sliding door 120 is in the fully closed position as viewed from the second direction Y. As illustrated in FIG. 7, the shielding member 4 covers the electric wire W inside the protector 2 from the external space. The height of the shielding member 4 is determined in such a manner as to be able to cover the electric wire W from the upper end to the lower end thereof. The length of the shielding member 4 is determined in such a manner that the electric wire W inside the protector 2 is not visually recognized when viewed from the second direction Y.

More specifically, the length of the shielding member 4 is set on the basis of an opening width L1 between the rotating member 3 and the protector 2. The opening width L1 is a length from an end 31a of the rotating member 3 to an end 64a of the protector 2 in the first direction X. The end 31a is an end on the rotation center side of the cylindrical portion 31. The end 64a is an end of the first side wall 64 of the protector body 6 on the first opening 60a side. The length of the shielding member 4 is equal to or larger than the opening width L1.

An arrow AR1 illustrated in FIG. 6 is the rotation direction of the rotating member 3 when the sliding door 120 is opened. The rotation direction of the arrow AR1 is referred to as a “first rotation direction”. When the rotating member 3 rotates in the direction of the arrow AR1, the shielding member 4 slides by being pushed by the rotating member 3. The sliding direction at this point is a direction approaching the second opening 60b along the guide groove 63.

Illustrated in FIG. 8 is the inside of the protector 2 when the sliding door 120 is at the fully open position. In FIG. 8, the cover 7 of the protector 2 and the second member 9 of the rotating member 3 are omitted. When the sliding door 120 is at the fully open position, the second shaft portion 42 of the shielding member 4 is positioned at the second end 63b of the guide groove 63. The electric wire W is curved inside the protector 2. The electric wire W includes a first extending portion W1, a second extending portion W2, and a curved portion W3. The first extending portion W1 is a portion extending in the second direction Y from the protector 2 towards the vehicle body 110. The second extending portion W2 is a portion extending in the routing path 60 of the protector 2 along the first direction X. The curved portion W3 is a portion curved between the first extending portion W1 and the second extending portion W2.

The shielding member 4 is accommodated in a space between the first side wall 64 of the protector 2 and the second extending portion W2 of the electric wire W. Since the shielding member 4 is located on an inner side in the curving direction with respect to the curved electric wire W, the shielding member 4 is unlikely to be interfered with the electric wire W.

FIG. 9 is a front view of the protector 2 and the rotating member 3 when the sliding door 120 is at the fully open position as viewed from the space 130 on the vehicle body 110 side. As illustrated in FIG. 9, the rotating member 3 covers the electric wire W inside the protector 2. As illustrated in FIGS. 8 and 9, the shielding member 4 overlaps the rotating member 3 and is hidden by the rotating member 3 when viewed from the second direction Y.

When the sliding door 120 rotates from the fully open position towards the fully closed position, the rotating member 3 rotates in a direction indicated by an arrow AR2 in FIG. 8. The rotation direction of the arrow AR2 is referred to as a “second rotation direction”. When the rotating member 3 rotates in the second rotation direction, the shielding member 4 slides in conjunction with the rotation of the rotating member 3. The direction of movement of the shielding member 4 at this point is a direction away from the second opening 60b along the first direction X. The shielding member 4 moves in conjunction with the rotation of the rotating member 3 while covering the electric wire W inside the protector 2.

As described above, the routing structure 1 of the present embodiment is structured such that the electric wire W inside the protector 2 is not visually recognized from the vehicle body 110 side when the sliding door 120 is at the fully closed position, at the fully open position, and is moving. Therefore, the routing structure 1 of the present embodiment can suppress deterioration in appearance due to the electric wire W being visually recognized by the user.

As described above, the routing structure 1 of the present embodiment includes the protector 2, the electric wire W, the rotating member 3 having the cylindrical shape, and the shielding member 4. The protector 2 is disposed on the sliding door 120 of the vehicle 100. The electric wire W connects the vehicle body 110 of the vehicle 100 and the sliding door 120. The rotating member 3 is rotatably supported by the protector 2, and the electric wire W is inserted into the rotating member 3. The shielding member 4 follows the rotation of the rotating member 3 while sliding with respect to the protector 2.

The protector 2 has the routing path 60 through which the electric wire W drawn out from the rotating member 3 towards the sliding door 120 is routed. The shielding member 4 is disposed closer to the vehicle body 110 than to the electric wire W in the routing path 60 and covers the electric wire W from the space 130 on the vehicle body 110 side. The routing structure 1 of the present embodiment includes the shielding member 4 that covers the electric wire while following the rotation of the rotating member 3. Therefore, the routing structure 1 of the present embodiment can achieve the effect that the electric wire W is hardly visually recognized from the space 130 on the vehicle body 110 side.

The shielding member 4 of the present embodiment is connected to the rotating member 3. The protector 2 has the guide groove 63 that guides the shielding member 4. The shielding member 4 is connected to the rotating member 3 and follows the rotation of the rotating member 3 while being guided by the guide groove 63. With such a configuration, the shielding member 4 can be slid along a predetermined locus.

### First Modification of Embodiment

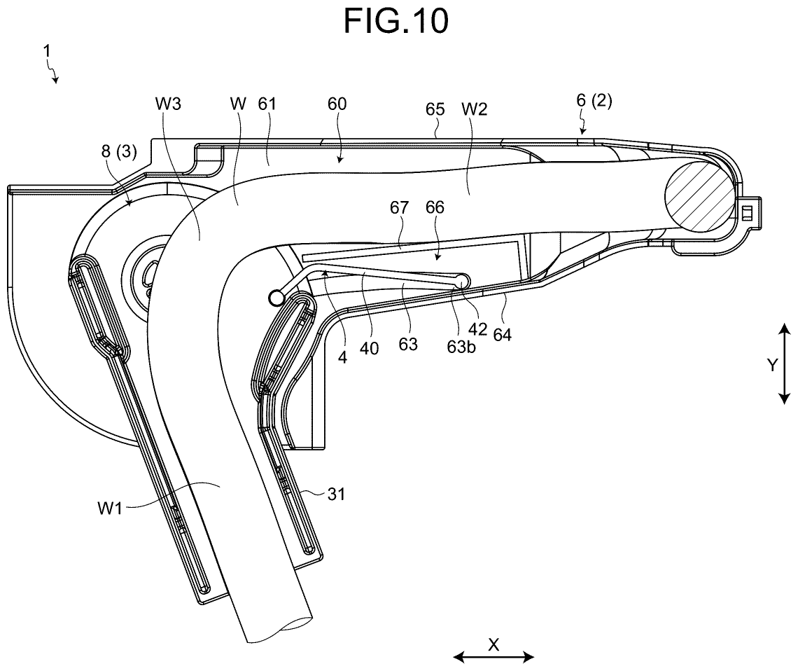

A first modification of the embodiment will be described with reference to FIG. 10. FIG. 10 is a diagram illustrating the internal structure of a protector according to the first modification of the embodiment. A routing structure 1 of the first modification of the embodiment is different from the routing structure 1 of the above embodiment in that, for example, the protector 2 includes a housing chamber 66 that houses the shielding member 4.

Similarly to the shielding member 4 of the above embodiment, a shielding member 4 of the first modification slides along the extending direction of the electric wire W in the routing path 60. As illustrated in FIG. 10, the protector 2 of the first modification includes the housing chamber 66. The housing chamber 66 is included inside the protector body 6 and is disposed on the first side wall 64 side with respect to the routing path 60. The housing chamber 66 has a partition wall 67. The partition wall 67 is erected from the bottom wall 61 of the protector body 6. The partition wall 67 extends along the routing direction of the electric wire W in the routing path 60 and separates the electric wire W and the shielding member 4.

The guide groove 63 is disposed between the partition wall 67 and the first side wall 64. Therefore, the guide groove 63 can guide the shielding member 4 to the inside of the housing chamber 66 when the sliding door 120 is opened.

As described above, in the routing structure 1 according to the first modification of the embodiment, the shielding member 4 slides along the extending direction of the electric wire W in the routing path 60. The protector 2 has the housing chamber 66 that houses the shielding member 4. The housing chamber 66 has the partition wall 67 that separates the shielding member 4 and the electric wire W. Therefore, the routing structure 1 of the first modification can suppress interference between the electric wire W and the shielding member 4.

### Second Modification of Embodiment

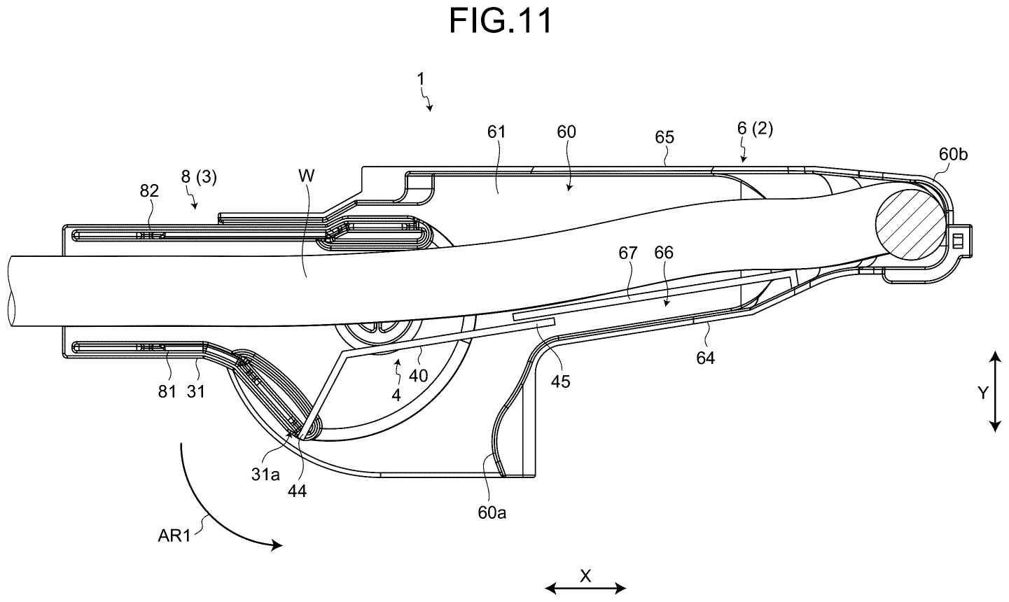

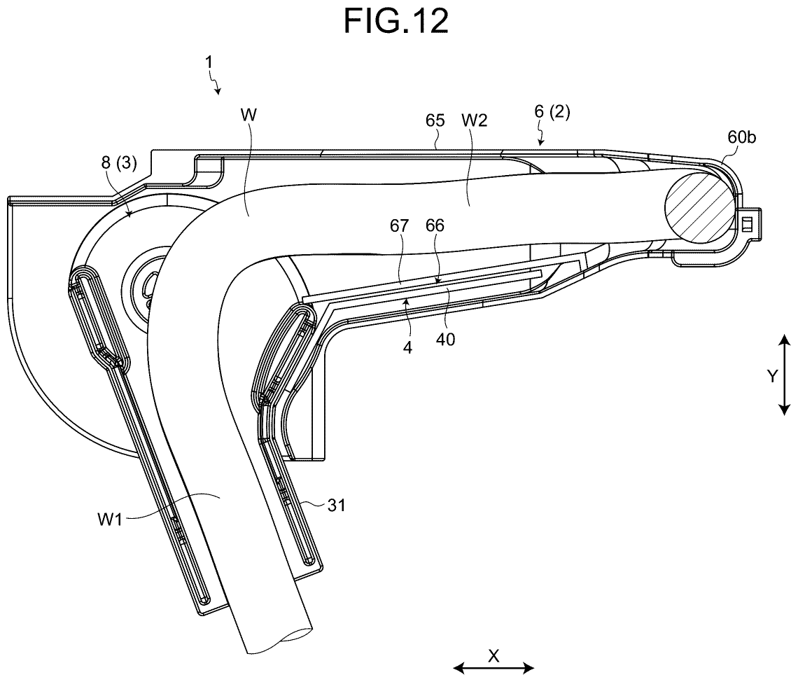

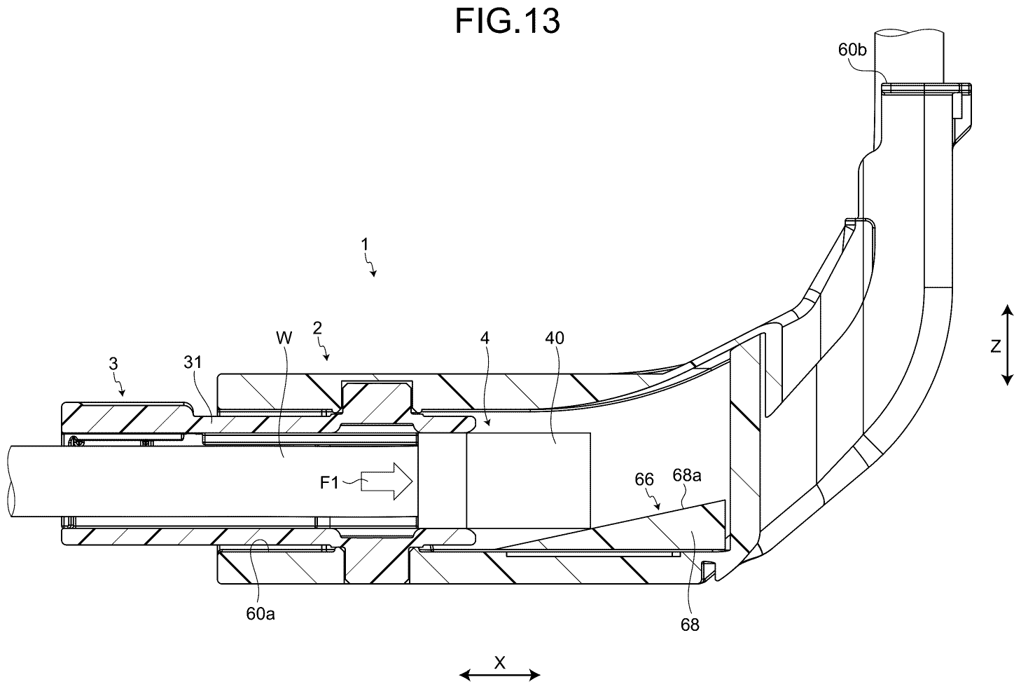

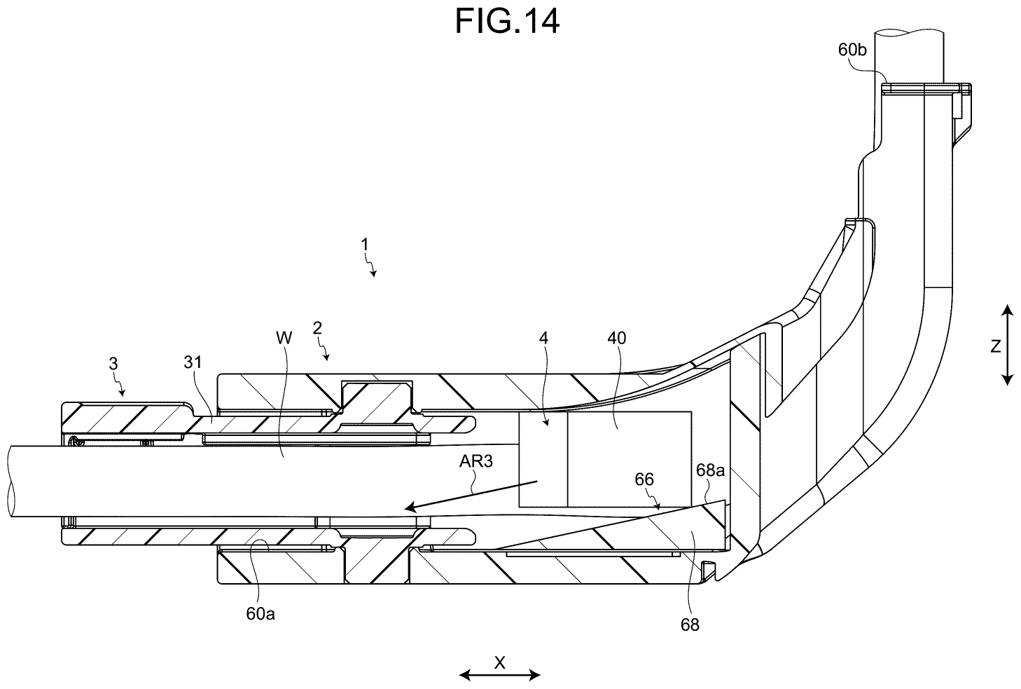

A second modification of the embodiment will be described with reference to FIGS. 11 to 14. A routing structure 1 of the second modification of the embodiment is different from the routing structure 1 of the above embodiment in that, for example, the shielding member 4 is caused to follow the rotation of the rotating member 3 using the weight of the shielding member 4 itself. FIGS. 11 and 12 are diagrams illustrating the internal structure of a protector according to the second modification of the embodiment, and FIGS. 13 and 14 are cross-sectional views of the routing structure according to the second modification of the embodiment.

As illustrated in FIG. 11, the protector 2 of the second modification has a housing chamber 66 similar to the housing chamber 66 of the first modification. The housing chamber 66 has a partition wall 67 that separates the electric wire W and the shielding member 4. The partition wall 67 is erected from the bottom wall 61 of the protector body 6 and extends along the extending direction of the electric wire W in the routing path 60.

The shielding member 4 of the second modification is not connected with the rotating member 3 and can slide independently from the rotating member 3. The shielding member 4 has a body 40 similar to the body 40 of the above embodiment. The body 40 has a first end 44 and a second end 45. The first end 44 is one end of the body 40 in the first direction X. The shielding member 4 slides in the first direction X while being guided by the partition wall 67 and the first side wall 64.

The end 31a of the rotating member 3 is disposed on a locus of the first end 44 when the shielding member 4 slides. The rotating member 3 is structured to be rotatable while the end 31a is kept being in contact with the first end 44. Therefore, the rotating member 3 can slide the shielding member 4 to the back portion of the housing chamber 66 while rotating in the direction of the arrow AR1.

The second end 45 of the shielding member 4 is the other end of the body 40 in the first direction X. Illustrated in FIG. 11 is the inside of the protector 2 when the sliding door 120 is at the fully closed position. When the sliding door 120 is in the fully closed position, the second end 45 of the shielding member 4 is inserted into the housing chamber 66. Therefore, the shielding member 4 can shield the electric wire W inside the protector 2 from the external space when the sliding door 120 is at the fully closed position.

An arrow AR1 illustrated in FIG. 11 is a rotation direction of the rotating member 3 when the sliding door 120 is opened. When the sliding door 120 is opened, the end 31a of the rotating member 3 pushes the shielding member 4 into the housing chamber 66.

Illustrated in FIG. 12 is the inside of the protector 2 when the sliding door 120 is at the fully open position. The shielding member 4 is housed in the housing chamber 66 and is locked by the rotating member 3.

Illustrated in FIG. 13 is a cross section of the housing chamber 66 along the first direction X. A bottom wall 68 of the housing chamber 66 has an inclined surface 68a. The inclined surface 68a is inclined upward from the first opening 60a towards the second opening 60b along the first direction X. When the rotating member 3 rotates as indicated by the arrow AR1 in FIG. 11, the rotating member 3 presses the shielding member 4. As illustrated in FIG. 13, a pressing force F1 at this point is a force applied in a direction in which the shielding member 4 is pushed into the back of the housing chamber 66. With this pressing force F1, the shielding member 4 is inserted into the housing chamber 66 while sliding on the inclined surface 68a. When the sliding door 120 moves up to the fully open position, the rotating member 3 stops rotating and locks the shielding member 4 in a state of being accommodated in the housing chamber 66.

When the sliding door 120 moves from the fully open position towards the fully closed position, the rotating member 3 rotates in a direction opposite to the arrow AR1. As a result, the locking of the rotating member 3 with respect to the shielding member 4 is released. When the locking is released, the shielding member 4 slides down along the inclined surface 68a as indicated by an arrow AR3 in FIG. 14. That is, the shielding member 4 slides in a direction opposite to the insertion direction to the housing chamber 66. Therefore, the shielding member 4 can follow the rotation of the rotating member 3 while sliding on the inclined surface 68a.

As described above, when rotating in the first rotation direction, the rotating member 3 according to the second modification of the embodiment presses the shielding member 4 to insert the shielding member 4 into the housing chamber 66. The protector 2 has the inclined surface 68a. The inclined surface 68a causes the shielding member 4 to slide in the direction opposite to the insertion direction to the housing chamber 66. Therefore, in the routing structure 1 of the second modification, the shielding member 4 can be caused to follow the rotation of the rotating member 3.

### Third Modification of Embodiment

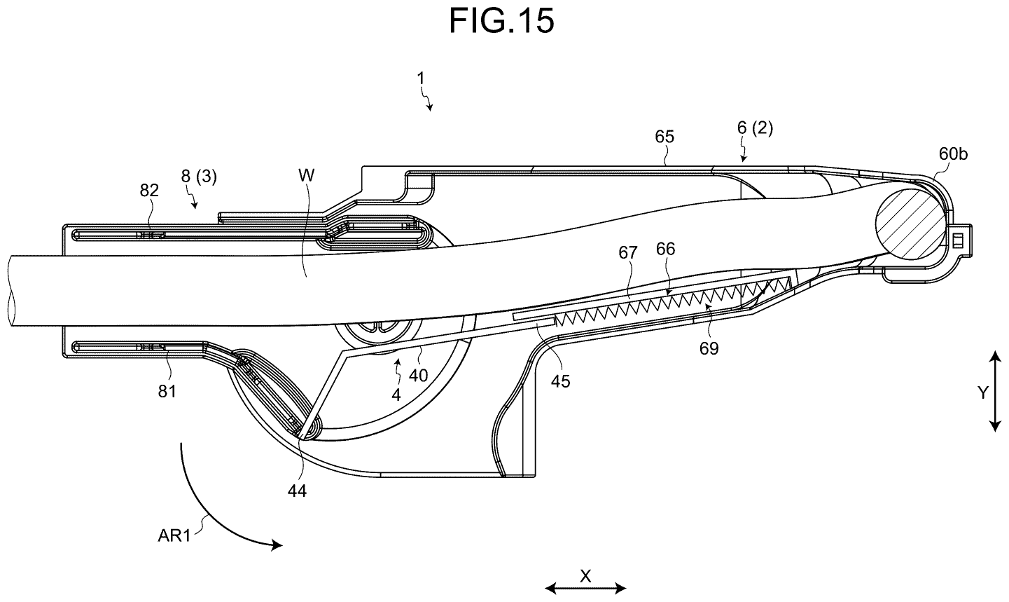

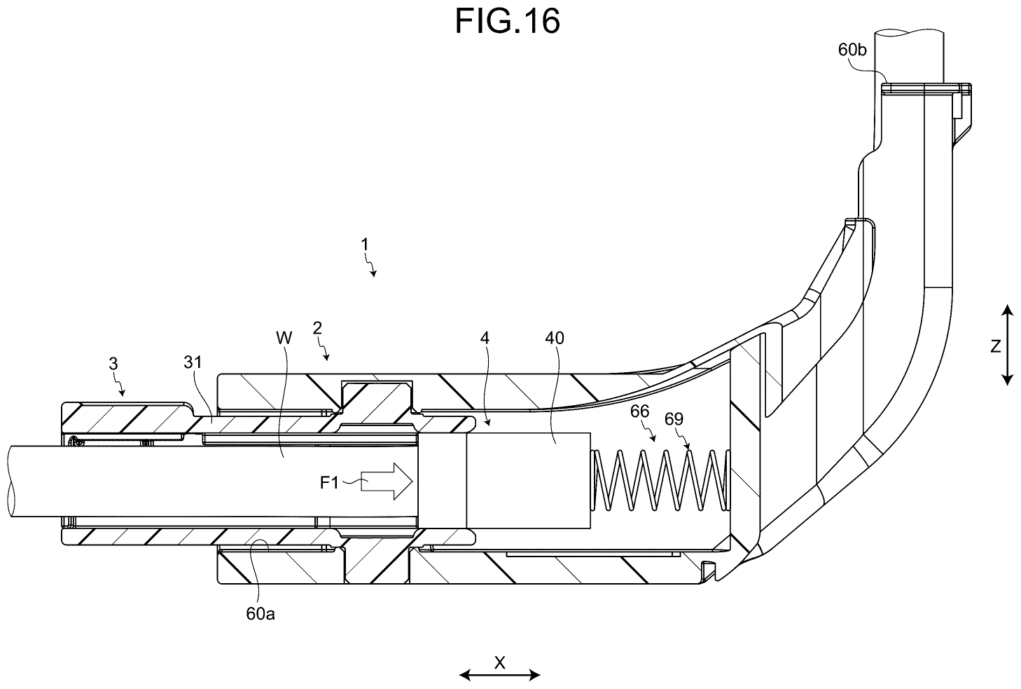

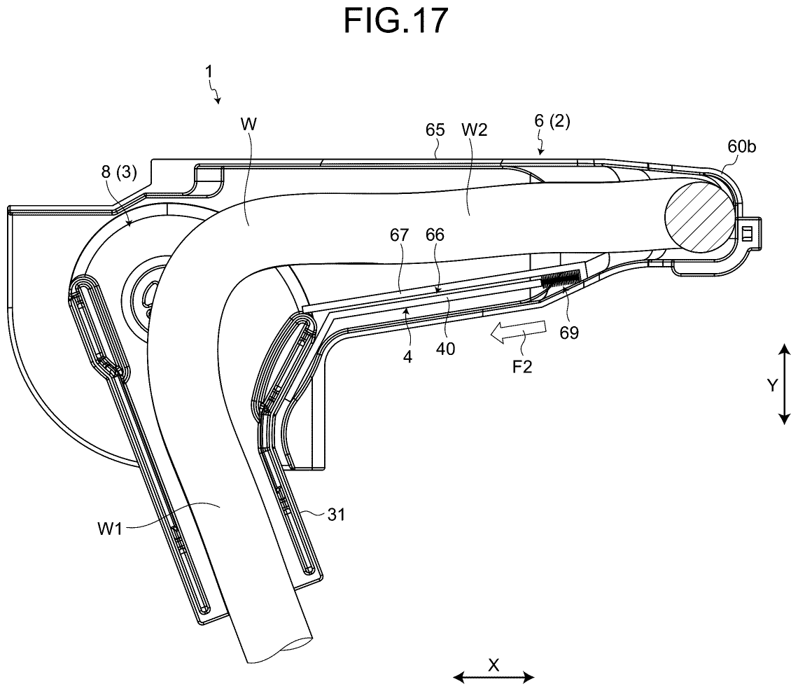

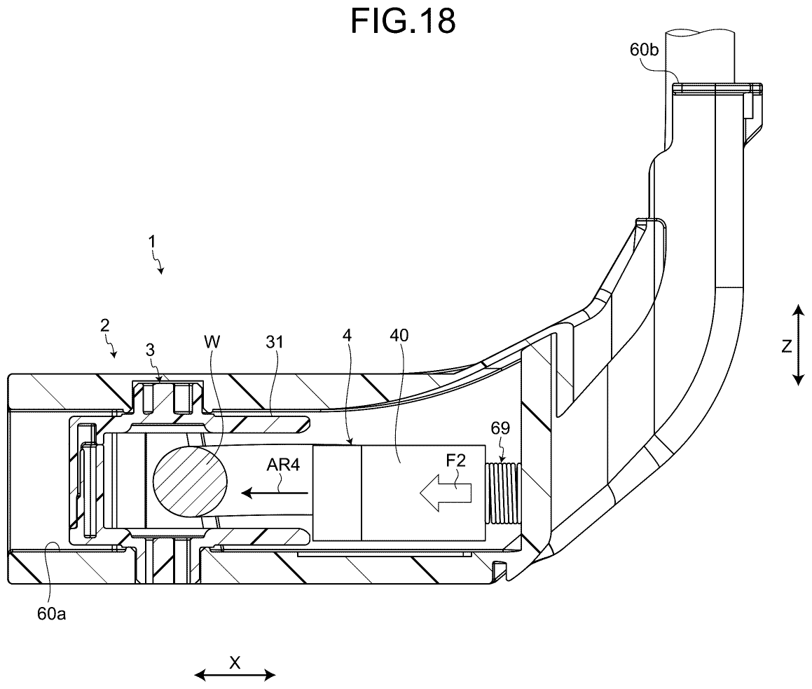

A third modification of the embodiment will be described with reference to FIGS. 15 to 18. A routing structure 1 of the third modification of the embodiment is different from the routing structure 1 of the above embodiment in that, for example, a spring 69 that biases the shielding member 4 is included. FIG. 15 is a diagram illustrating the internal structure of a protector according to a third modification of the embodiment, FIG. 16 is a cross-sectional view of the routing structure according to the third modification of the embodiment, FIG. 17 is a diagram illustrating the internal structure of the protector according to the third modification of the embodiment, and FIG. 18 is a cross-sectional view of the routing structure according to the third modification of the embodiment.

As illustrated in FIGS. 15 and 16, the routing structure 1 according to the third modification of the embodiment includes the spring 69 disposed in the housing chamber 66. The spring 69 is, for example, a coil spring. The spring 69 extends in the first direction X and generates a biasing force in the first direction X. One end of the spring 69 is in contact with the shielding member 4, and the other end of the spring 69 is in contact with the protector body 6. The spring 69 presses the shielding member 4 towards the rotating member 3.

Illustrated in FIGS. 15 and 16 is the shielding member 4 and the spring 69 when the sliding door 120 is at the fully closed position. The spring 69 is compressed between the shielding member 4 and the protector body 6 when the sliding door 120 is at the fully closed position. The spring 69 can suppress the vibration of the shielding member 4 by pressing the shielding member 4 towards the rotating member 3.

When the rotating member 3 rotates as indicated by an arrow AR1 in FIG. 15, the rotating member 3 presses the shielding member 4. As illustrated in FIG. 16, the pressing force F1 at this point is a force applied in a direction in which the shielding member 4 is pushed into the back of the housing chamber 66. With this pressing force F1, the shielding member 4 is inserted into the housing chamber 66 while compressing the spring 69. When the sliding door 120 moves up to the fully open position, the rotating member 3 stops rotating and locks the shielding member 4 in a state of being accommodated in the housing chamber 66. Illustrated in FIG. 17 is the rotating member 3, the shielding member 4, and the spring 69 when the sliding door 120 is at the fully open position. The spring 69 applies a biasing force F2 to the shielding member 4. The biasing force F2 is a force applied in a direction to push out the shielding member 4 from the housing chamber 66. The rotating member 3 locks the shielding member 4 against the biasing force F2.

When the sliding door 120 moves from the fully open position towards the fully closed position, the rotating member 3 rotates in a direction opposite to the arrow AR1. As a result, the locking of the shielding member 4 by the rotating member 3 is released. When the locking is released, the shielding member 4 moves by the biasing force F2 of the spring 69. As indicated by an arrow AR4 in FIG. 18, the shielding member 4 slides towards the first opening 60a. The spring 69 presses the shielding member 4 towards the rotating member 3 and causes the shielding member 4 to follow the rotation of the rotating member 3.

As described above, when rotating in the first rotation direction, the rotating member 3 according to the third modification presses the shielding member 4 to insert the shielding member 4 into the housing chamber 66. The spring 69 is disposed in the housing chamber 66. The spring 69 biases the shielding member 4 in the direction opposite to the insertion direction to the housing chamber 66. Therefore, in the routing structure 1 of the third modification, the shielding member 4 can be caused to follow the rotation of the rotating member 3.

The content disclosed in the above embodiment and the modifications can be implemented in combination as appropriate.

A routing structure according to the present embodiment includes: a protector disposed on a sliding door of a vehicle; an electric wire that connects a vehicle body and the sliding door of the vehicle; a rotating member rotatably supported by the protector, the rotating member having a cylindrical shape through which the electric wire is inserted; and a shielding member that follows rotation of the rotating member while sliding with respect to the protector. The shielding member is disposed closer to the vehicle body than to the electric wire in the routing path and covers the electric wire from the space on the vehicle body side. According to the routing structure of the present embodiment, there is an effect that the electric wire is hardly visually recognized.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a protector disposed on a sliding door of a vehicle;
an electric wire connecting a vehicle body of the vehicle and the sliding door;
a rotating member rotatably supported by the protector, the rotating member having a cylindrical shape through which the electric wire is inserted; and
a shielding member that follows rotation of the rotating member while sliding with respect to the protector, wherein
the protector has a routing path through which the electric wire drawn out from the rotating member towards the sliding door is routed, and
the shielding member is disposed closer to the vehicle body than to the electric wire in the routing path and covers the electric wire from a space on the vehicle body side.

2. The routing structure according to claim 1, wherein
the shielding member is connected to the rotating member, and
the protector has a guide groove that guides the shielding member.

3. The routing structure according to claim 1, wherein
the shielding member slides along an extending direction of the electric wire in the routing path,
the protector includes a housing chamber that houses the shielding member, and
the housing chamber has a partition wall that separates the shielding member and the electric wire.

4. The routing structure according to claim 3 wherein,
the rotating member inserts the shielding member into the housing chamber by pressing the shielding member when rotating in a first rotation direction, and
the protector has an inclined surface that causes the shielding member to slide in a direction opposite to an insertion direction to the housing chamber.

5. The routing structure according to claim 3, wherein
the rotating member inserts the shielding member into the housing chamber by pressing the shielding member when rotating in a first rotation direction, and
a spring is disposed in the housing chamber, the spring biasing the shielding member in a direction opposite to an insertion direction to the housing chamber.
